(19) United States
(12) Patent Application Publication
(10) Pub. No.: US 2010/0064432 A1
(43) Pub. Date: Mar. 18, 2010

(54) INFECTION CONTROL LIFTING STRAP

(76) Inventors: Noel DUQUETTE, Barrie (CA); Samuel Andrew GIBNEY, Barrie (CA); Stephen Van NOORTWYK, Barrie (CA); Ivan CLARK, Barrie (CA)

Correspondence Address: NIXON PEABODY, LLP, 401 9TH STREET, NW, SUITE 900, WASHINGTON, DC, 20004-2128, US

(21) Appl. No.: 12/558,077

(22) Filed: Sep. 11, 2009

Related U.S. Application Data
(60) Provisional application No. 61/095,970, filed on Sep. 11, 2008.

(51) Int. Cl. A61G 7/10

(52) U.S. Cl. 5/88.1

(57) ABSTRACT

A support member for use in a patient lifting device is described. The support member includes an improved lift strap having an inner core and an outer plastic layer that can be easily and effectively cleaned with standard disinfectant. The lift strap is secured to a patient lifting device with a spool assembly that guides the lift strap and a belt clamp assembly that compresses the lift strap and holds it into place. In the preferred embodiment, the support member is used in an electric ceiling- or floor-mounted patient lifting device. The preferred lifting device is composed of a track component attached to a winch assembly. The winch assembly has an electric motor that raises and lowers the lift strap by means of a spool assembly and belt clamp assembly. The belt clamp assembly attaches to a sling that supports the patient while he or she is displaced.

### RELATED APPLICATION

This application claims the benefit of U.S. Provisional Patent Application No. 61/095,970, which was filed on Sep. 11, 2008. The content of the U.S. Provisional Patent Application are incorporated below by reference.

### BACKGROUND OF THE INVENTION

1. Field of the Invention

The present invention relates to a support member and patient lifting device for displacing persons between various positions and locations. More specifically, the present invention relates to an infection control lifting strap and system for lifting and positioning patients using a non-porous, sealed strap to provide improved infection control.

2. Description of Related Art

Patient lifting devices allow persons to be displaced between various positions and locations. The devices are typically used to life and move patients that may not be otherwise moved without injury or substantial effort by either the patient or the caregiver. The patient needing intervention from a lifting device is usually overweight, dystrophied, unconscious, or injured.

A traditional patient lifting device uses manual labor to displace the patient. Manual patient lifting devices may use hydraulic pumps or other fluid- or air-powered pumps to assist the caregiver moving the patient. The pump is attached to a lever that the caretaker may raise and lower to displace the patient into various positions and locations. Depending on the strength and experience of the caretaker, as well as the type of pump used, this type of device may be difficult or even dangerous to use for both the patient and the caretaker. However, it is still readily available due to its lower cost.

More recent patient lifting devices are electrically operated. Electric patient lifting devices utilize a motor system to raise and lower the patient. Once the patient is secured to the device, the caretaker simply uses a button or switch to cause the motor to displace the patient. Electric patient lifting devices have become the preferred devices due to their ease of use and minimal human involvement, limiting the risk of misuse and accident, or injury to the patient and caregiver. Furthermore, electric patient lifting devices do not require an exterior lever, and as such, may be more compact and can more easily be wall- or ceiling-mounted, leaving floor space unoccupied.

Both ceiling- and floor-mounted electrical lifting devices have a motor and winch assembly attached to a fabric lifting strap. The fabric lifting strap is attached to a sling in which the patient sits or lays to be moved from one position into another. In order to load the patient into the sling, and in regular daily use, caregivers, patients, maintenance personnel, and housekeeping staff may touch or grab the fabric lifting strap multiple times. Unfortunately, fabric lifting straps are exceedingly difficult to properly disinfect.

Although some lifting devices are positioned in family homes, most are used in group settings, such as assisted living facilities, nursing homes, doctor's offices, and hospitals. These group locations may use a single lifting device to transport multiple patients throughout the day. The patients may have different diseases or conditions that can be spread through multiple uses of the same device. Such a spread of potentially dangerous pathogens is undesirable, especially in group locations where widespread sickness could occur.

### SUMMARY OF THE INVENTION

Therefore, there is a need for a lifting device that minimizes the risk of cross-contamination between patients, as well as between patients and caregivers. The present invention answers that need by providing for a non-porous, completely sealed, plastic lifting strap that can be easily and quickly wiped down with any standard hard surface disinfectant. In addition, the infection control lifting strap of the present invention has a sturdy metal core that is more durable and reliable than a conventional fabric strap.

A support member for use in a patient lifting device is described. The support member includes an improved lift strap having an inner core and an outer plastic layer that can be easily and effectively cleaned with standard disinfectant. The lift strap is secured to a patient lifting device with a spool assembly that guides the lift strap and a belt clamp assembly that compresses the lift strap and holds it in place.

In one embodiment, the support member is used in an electric ceiling- or floor-mounted patient lifting device. The lifting device includes a track component attached to a winch assembly. The winch assembly has an electric motor that raises and lowers the lift strap by means of a spool assembly and belt clamp assembly. The belt clamp assembly attaches to a sling that supports the patient while he or she is displaced.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a diagram illustrating a patient lifting device with a lift strap assembly in accordance with the present invention.

FIG. 2A-2B are cross-sections of a lift strap according to certain embodiments of the present invention.

FIG. 3 is a diagram illustrating the components of a lift strap assembly according to one embodiment of the present invention.

FIG. 4 is a diagram illustrating a belt clamp assembly and lift strap according to another embodiment of the present invention.

FIG. 5A-5B are diagrams of belt clamps according to other embodiments of the present invention.

FIG. 6 is a diagram illustrating a belt spool assembly according to one embodiment of the present invention.

FIG. 7 is a diagram illustrating a welded lift strap according to one embodiment of the present invention.

### DETAILED DESCRIPTION

A support member, including an improved lift strap, for use in a patient lifting device is described. In the following description, for purposes of explanation, numerous specific details are set forth in order to provide a thorough understanding of the exemplary embodiments. It is apparent to one skilled in the art, however, that the present invention can be practiced without these specific details or with an equivalent arrangement.

The present invention provides a support member for use in a patient lifting device. The support member includes a lift strap having an inner core and an outer non-porous plastic layer and means for securing the lift strap to the patient lifting device. The means for securing the lift strap to the patient lifting device include a cylindrical spool operably connected to a first end of the lift strap, where the spool has at least one strap guard positioned at a distal end of the spool. The means for securing the lift strap to the patient lifting device further include one or more cylindrical thickness rollers having an exterior guiding channel configured to support the lift strap and a belt clamp assembly operably connected to a second end of the lift strap.

Likewise, the present invention provides a patient lifting device for displacing persons between various positions or areas. A patient lifting device in accordance with the present invention includes a track component, an electric motor connected to the track component, a lift strap having an inner core and an outer non-porous plastic layer, means for securing the lift strap to the track component, a belt clamp assembly operably connected to a second end of the lift strap, a lifting frame operably connected to the belt clamp assembly, and a sling. The means for securing the lift strap to the track component include a cylindrical spool operably connected to a first end of the lift strap, where the spool has at least one strap guard positioned at a distal end of the spool. The means for securing the lift strap to the track component also includes one or more cylindrical thickness rollers having an exterior guiding channel configured to support the lift strap and a belt clamp assembly operably connected to a second end of the lift strap.

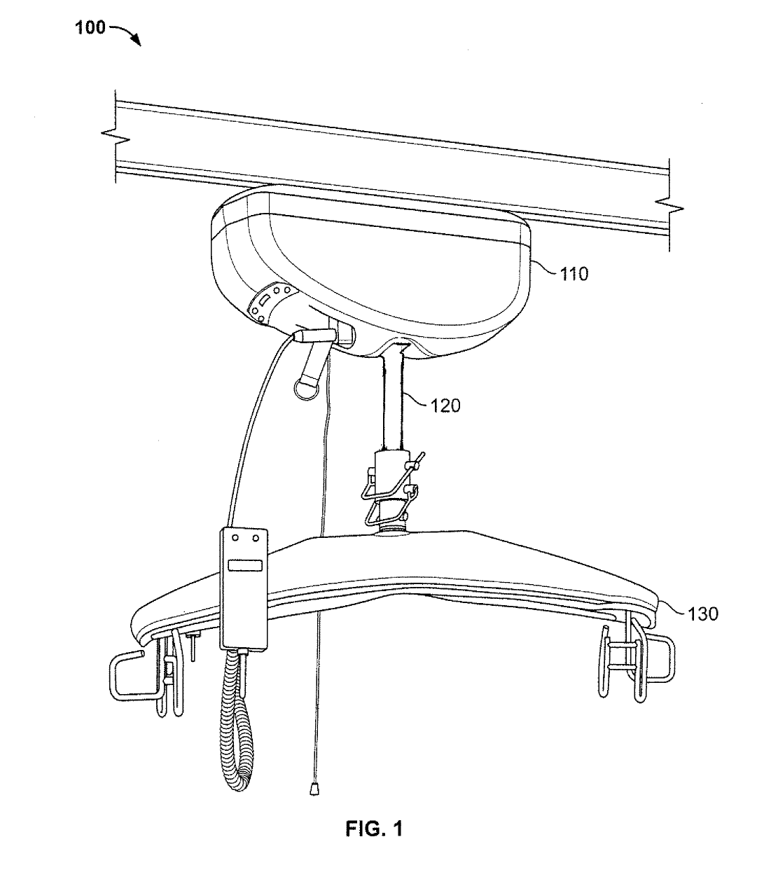

Referring now to the drawings, wherein like reference numerals designate identical or corresponding parts throughout the several views, FIG. 1 shows a patient lifting device 100 for displacing persons between various positions or areas according to one embodiment of the present invention. Housing component 110 includes a track component connected to an electric motor (not shown). The electric motor drives the movement of the lift strap through a gear and spool assembly, described below. Lift strap 120 extends from housing component 110 to lifting frame 130. A lifting sling may be removably attached to lifting frame 130.

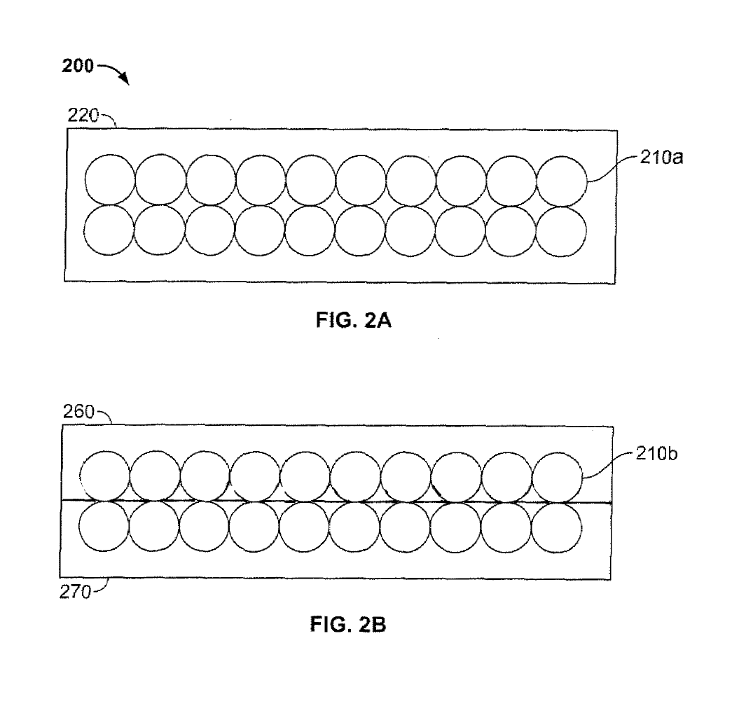

FIGS. 2A and 2B illustrate cross-sections of lift straps in accordance with embodiments of the present invention. FIG. 2A shows cross-section of lift strap 200 having inner core 210a and outer non-porous layer 220. Inner core 210a is composed of a plurality of thin reinforcing strands that may be a high-strength, high-flexibility material. For example, inner core 210 may be comprised of strands of a high-strength, high-flexibility material with good chemical and corrosion resistance, such as high strength steel, stainless steel, carbon fibers, or Kevlar®. Outer non-porous layer 220 may be plastic, but may also be any other non-porous materials or flexible food grade plastics, such as polyurethane, polystryrene, polytetrafluoroethylene, nylon, or acetal. Outer non-porous layer 220 is suitable for continuous and effective cleaning with diluted cleaning agents, particularly those found in acute and long-term care facilities. In one embodiment, lift strap 200 is ultra-thin, preferably 0.083 inches or thinner, so that the diameter of lift strap 200 on a spool varies little when lift strap 200 is wound. This results in lower overall current draw on the motor and a smaller increment in current draw between fully extended and fully retracted positions.

FIG. 2B shows cross-section of lift strap 250 also having inner core 210. Lift strap 250 has outer non-porous top layer 260 and outer non-porous bottom layer 270, with outer non-porous top layer 260 having a higher coefficient of friction, μ, than outer non-porous bottom layer 270. Outer non-porous top layer 260 and outer non-porous bottom layer 270 may also be a non-porous material, such as plastic or polyurethane, and may be made of the same or different materials. A higher coefficient of friction may be produced on outer non-porous top layer 260 than on outer non-porous bottom layer 270 by a number of methods, including using a more frictional material than is used on outer non-porous bottom layer 270, applying a coating to top layer 260, or by etching top layer 260. Outer non-porous top layer 260 is positioned facing the interior of a spool assembly to gain the benefit of the difference in the coefficients of friction and to prevent lift strap 250 from slipping, squeaking, or tightening on itself.

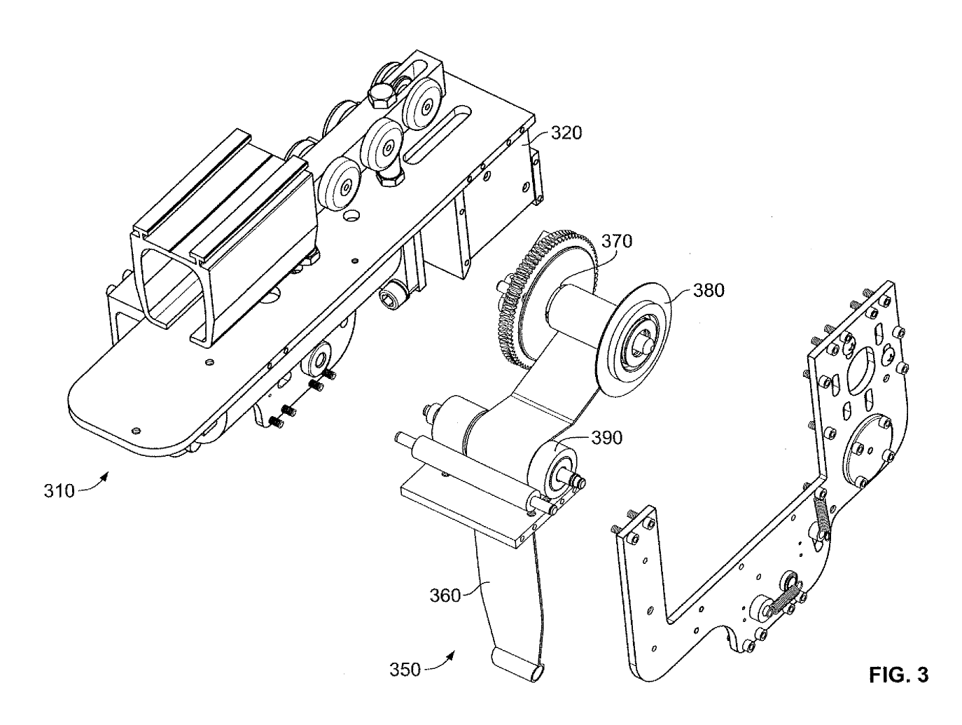

FIG. 3 illustrates the components of a lift strap assembly according to one embodiment of the present invention. Track component 310 houses electric motor 320 and is configured to house spool assembly 350. Strap winding assembly 350 is configured to connect lift strap 360 to track component 310. Strap winding assembly 350 includes spool 370 with strap guard 380 positioned on one end of spool 370.

Spool 370 may have a cylindrical or other rounded edge shape that allows for smooth winding and dewinding of lift strap 360 at a relatively constant speed. Spool 370 has a diameter that maintains a constant shear stress on lift strap 360. Spool 370 is of sufficient diameter that lift strap 360 does not become damaged or destroyed in use by tangling, overlapping, or otherwise winding upon itself. Strap guard 380 may be made of a conductive material, such as aluminum, to prevent the friction of lift strap 360 from generating high temperatures as lift strap 360 passes over guard 380. The aluminum or other conductive material may be used to radiate heat from lift strap 360. By conducting heat from like strap 360, lift strap 360 will not deform or change in cross-section area, which may affect performance. Lift strap 360 is wound onto spool 370 and is threaded through one or more thickness rollers 390. Lift strap 360 then extends gravitationally downwards to attach, for example, to lifting frame 130.

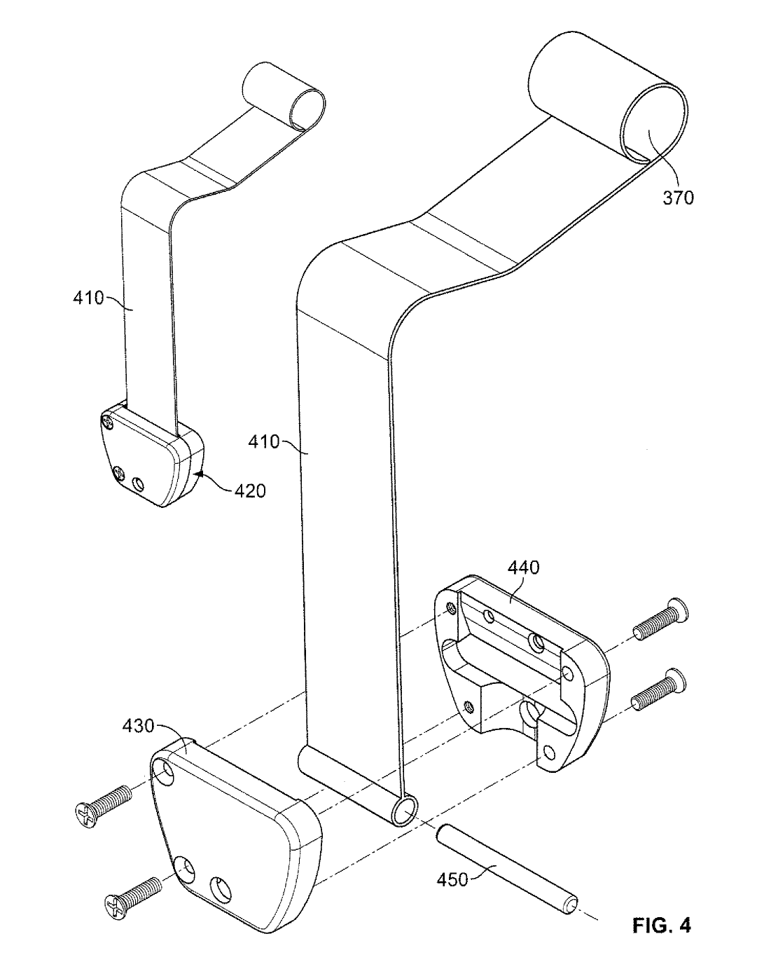

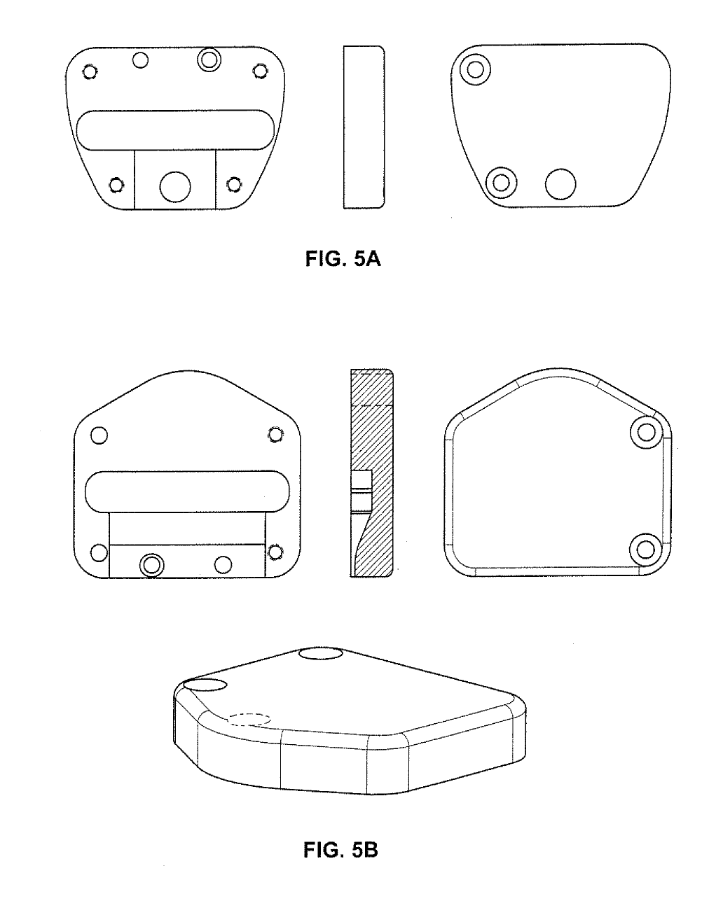

FIG. 4 illustrates belt clamp assembly 420 with lift strap 410. As shown in the larger exploded view in FIG. 4, lift strap 410 extends from spool 370 down to belt clamp sides 430 and 440. Lift strap 410 houses clamp pin 450 on its lower end and is compressed by clamp sides 430 and 440. Clamp sides 430 and 440 may be held together by fastening devices or materials, including basic screws, as shown. Clamp sides 430 and 440 secured in a fashion that does not damage or otherwise cause perforations on lift strap 410. Thus, advantageously, the maximum load weight of lift strap 410, typically between 1,000 and 3,200 pounds, is not weakened due to perforations, cuts, or holds caused by clamp sides 430 and 440. Furthermore, lift strap 410 is completely sealed and does not have recesses or crevices in which fluids or other materials may infiltrate, thereby minimizing bacterial, viral, and other germ growth. The sealed assembly thereby decreases the risk of infection to the patient, caregiver, or other operator or handler of the patient lifting device. A number of geometric variations are possible for clamp sides 430 and 440. For example, the clamp sides may have the shape of a rounded-edge trapezoid, as shown in FIG. 5A, or a rounded-edge pentagon, as shown in FIG. 5B, for example.

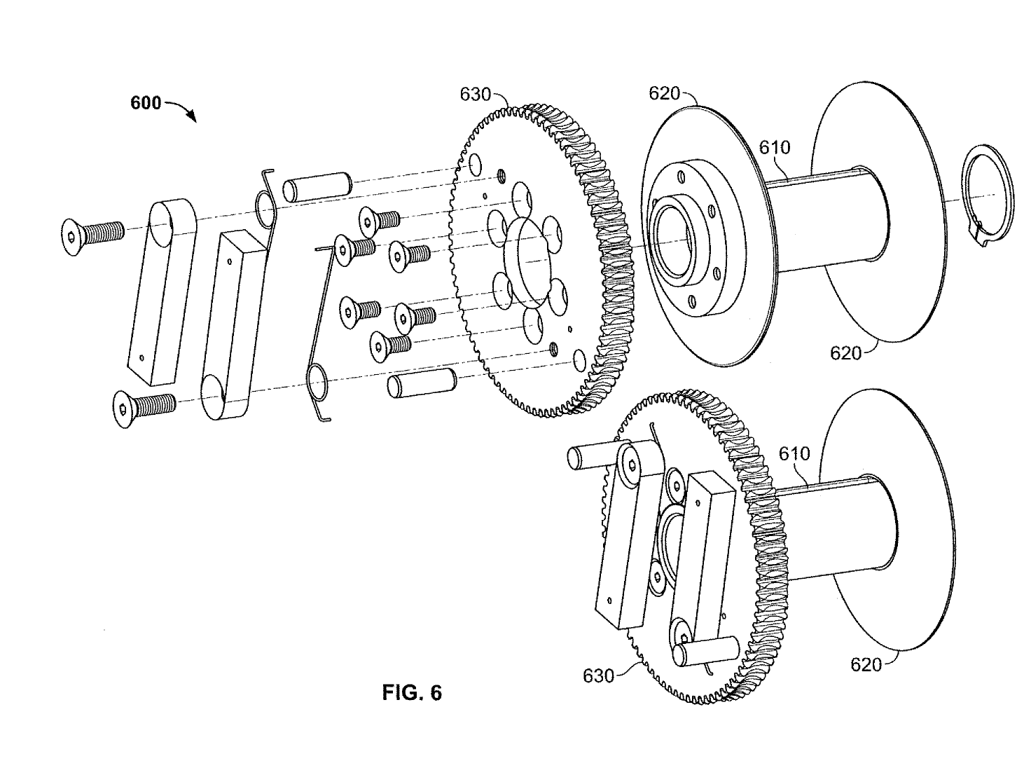

FIG. 6 is a detailed diagram illustrating belt spool assembly 600 according to one embodiment of the present invention. Spool assembly 600 includes spool 610, strap guards 620, and at least one gear wheel 630. As discussed above, it is preferred that spool 610 has a diameter that is not too small, and preferably 1.1 inches or greater, such that no significant shear stress is put on the lift strap so as not to damage or destroy it in use. Strap guards 620 function to protect the lift strap from wear caused by gear wheel 620, and to prevent any grease used on gear wheel 620 from getting on the lift strap. Strap guards 620 may be made of a conductive material, such as aluminum, so as to draw heat away from the lift strap and prevent heat damage to the strap. In operation, gear wheel 630 engages with a worm gear (not shown) on the motor of the patient lifting device to drive spool 610, which in turn winds and unwinds the lift strap from spool 610.

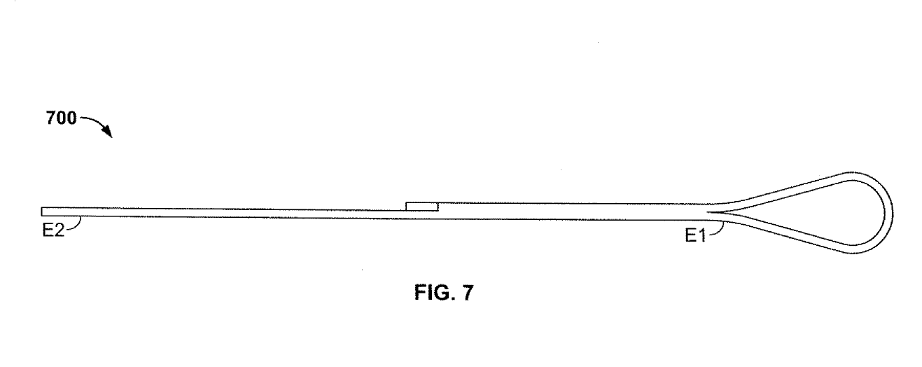

FIG. 7 is a side view of lift strap 700. At a first end E1, lift strap 700 is folded over itself and either welded to itself or bonded by adhesives to create a fastener-free loop with which to connect belt clamp assembly 420. Thus, when attached to belt clamp assembly 420, lift strap 700 is not damaged, perforated, stitched, or riveted through with mechanical fastenings, as discussed above. Advantageously, lift strap 700 is attached to lifting frame 130 in a manner that minimizes areas for moisture and germs to accumulate without weakening the strength of the belt.

The present invention has been described in relation to particular examples, which are intended in all respects to be illustrative rather than restrictive. Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A support member for use in a patent lifting device, said support member comprising:
a lift strap having an inner core and an outer non-porous plastic layer; and
means for securing said lift strap to said patient lifting device, said means for securing comprising:
a cylindrical spool operably connected to a first end of said lift strap, wherein said spool has at least one strap guard positioned at a distal end of said spool;
a cylindrical thickness roller having an exterior guiding channel configured to support said lift strap; and
a belt clamp assembly operably connected to a second end of said lift strap.

2. The support member of claim 1, wherein said non-porous plastic layer is polyurethane.

3. The support member of claim 1, wherein said inner core is constructed from at least one of high strength steel, stainless steel, carbon fiber, or Kevlar.

4. The support member of claim 1, wherein said lift strap has a higher coefficient of friction on one face of said lift strap than on the opposite face of said lift strap.

5. The support member of claim 1, wherein said cylindrical spool has a diameter that maintains a consistent shear stress on said lift strap.

6. The support member of claim 1, wherein said strap guard is made of a conductive material.

7. The support member of claim 6, wherein said strap guard is aluminum.

8. The support member of claim 1, wherein said belt clamp assembly consists of at least two strap clamps.

9. The support member of claim 1, wherein said belt clamp assembly is operably connected to said second end of said lift strap with a welded loop on said lift strap.

10. A patient lifting device for displacing persons between various positions or areas, said patient lifting device comprising:
a track component;
an electric motor connected to said track component;
a lift strap having an inner core and an outer non-porous plastic layer;
means for securing said lift strap to said track component, said means for securing comprising:
a cylindrical spool operably connected to a first end of said lift strap, wherein said spool has at least one strap guard positioned at a distal end of said spool;
one or more cylindrical thickness rollers having an exterior guiding channel configured to support said lift strap; and
a belt clamp assembly operably connected to a second end of said lift strap;
a lifting frame operably connected to said belt clamp assembly; and
a sling.

11. The patient lifting device of claim 10, wherein said non-porous plastic layer is polyurethane.

12. The patient lifting device of claim 10, wherein said inner core is constructed from at least one of high strength steel, stainless steel, carbon fiber, or Kevlar.

13. The patient lifting device of claim 10, wherein said lift strap has a higher coefficient of friction on one face of said lift strap than on the opposite face of said lift strap.

14. The patient lifting device of claim 10, wherein said cylindrical spool has a diameter that maintains a consistent shear stress on said lift strap.

15. The patient lifting device of claim 10, wherein said strap guard is made of a conductive material.

16. The patient lifting device of claim 16, wherein said strap guard is aluminum.

17. The patient lifting device of claim 10, wherein said belt clamp assembly consists of at least two strap clamps.

18. The patient lifting device of claim 10, wherein said belt clamp is operably connected to said second end of said lift strap with a welded loop on said lift strap.
